(19) United States
(12) Patent Application Publication
(10) Pub. No.: US 2021/0004723 A1
(43) Pub. Date: Jan. 7, 2021

(54) LEARNING DEVICE, LEARNING METHOD, AND LEARNING PROGRAM

(71) Applicant: NEC Corporation, Minato-ku, Tokyo (JP)

(72) Inventor: Go KANNO, Tokyo (JP)

(73) Assignee: NEC Corporation, Minato-ku, Tokyo (JP)

(21) Appl. No.: 16/982,798

(22) PCT Filed: Jan. 29, 2019
(86) PCT No.: PCT/JP2019/002867

§ 371 Date: Sep. 21, 2020

(30) Foreign Application Priority Data
Mar. 29, 2018 (JP) 2018-063833

(51) Int. Cl. G06N 20/00; G06N 5/02

(52) U.S. Cl. CPC G06N 20/00; G06N 5/02

(57) ABSTRACT

Provided is a learning device that can accurately exclude training data inappropriate for learning a model from training data and can learn the model. A selecting means 73 selects first training data and second training data. Using the first training data and the second training data, a second learning means 74 learns a second model for evaluating training data by machine learning. In a case where the second model has been generated at the time of learning a first model, a first learning means evaluates each of the training data by applying each of the training data to the second model, excludes training data of a prescribed evaluation, and learns the first model.

### TECHNICAL FIELD

The present invention relates to a learning device, a learning method, and a learning program that learn a model for determining a category to which data belongs by machine learning.

### BACKGROUND ART

In a case where a model for determining a category to which data belongs is learned by machine learning, the model is learned using training data collected in advance.

When training data includes training data not having a characteristic affecting determination of a category, accuracy of determining a learned model is reduced, or learning of a model is adversely affected. Therefore, it is necessary to remove training data not having a characteristic affecting determination of a category from collected training data. In general, after a model is learned, an expert manually examines training data based on a learned model, and manually removes training data to be removed.

In addition, PTL 1 describes a machine learning system that learns a correspondence between a feature and evaluation thereof based on feature information of each piece of data, and deletes training data inappropriate for machine learning from candidates of training data based on a learning result.

### CITATION LIST

### Patent Literature

PTL 1: Japanese Patent Application Laid-Open No. 2005-181928

### SUMMARY OF INVENTION

### Technical Problem

With improvement in accuracy of image recognition using machine learning such as deep learning, there is an increasing need for, for example, a process of automatically determining whether or not an object in an image corresponds to a prescribed object. In this case, an image of the prescribed object is collected as training data. At this time, it is difficult to collect only an image that clearly captures a characteristic affecting determination of whether or not an object in an image corresponds to the prescribed object due to restrictions such as imaging conditions.

Furthermore, in machine learning, in a case where it is not clarified which part of the prescribed object is a characteristic affecting determination of whether or not an object in an image corresponds to the prescribed object, it is unclear what image is suitable for learning. Therefore, it is more difficult to collect only an image that clearly captures such a characteristic as described above.

In addition, when a model is learned while training data includes data not suitable for learning, determination accuracy by the model is reduced.

Therefore, an object of the present invention is to provide a learning device, a learning method, and a learning program that can accurately exclude training data inappropriate for learning a model from training data and can learn the model.

### Solution to Problem

A learning device according to the present invention includes: a training data storage means that stores training data used for generating a first model for determining a category to which given data belongs, the training data being associated with a predetermined correct answer category; a first learning means that executes a first learning process of learning the first model by machine learning using the training data; a selecting means that executes a selecting process of determining a category to which the training data belongs by applying the training data to the first model, sorting the training data based on a difference between a category that is a determination result and a correct answer category corresponding to the training data, selecting a predetermined number of pieces of higher training data as first training data, and selecting a predetermined number of pieces of lower training data as second training data; and a second learning means that executes a second learning process of learning a second model for evaluating training data by machine learning using the first training data and the second training data, and is characterized in that execution of the first learning process by the first learning means, execution of the selecting process by the selecting means, and execution of the second learning process by the second learning means are repeated until a prescribed condition is satisfied, and in a case where the second model has been generated in the first learning process, the first learning means evaluates each of the training data by applying each of the training data to the second model, excludes training data of a prescribed evaluation, and learns the first model.

In addition, a learning method according to the present invention is characterized in that a computer including a training data storage means that stores training data used for generating a first model for determining a category to which given data belongs, the training data being associated with a predetermined correct answer category, executes a first learning process of learning the first model by machine learning using the training data, executes a selecting process of determining a category to which the training data belongs by applying the training data to the first model, sorting training data based on a difference between a category that is a determination result and a correct answer category corresponding to the training data, selecting a predetermined number of pieces of higher training data as first training data, and selecting a predetermined number of pieces of lower training data as second training data, executes a second learning process of learning a second model for evaluating training data by machine learning using the first training data and the second training data, repeats the first learning process, the selecting process, and the second learning process until a prescribed condition is satisfied, and in a case where the second model has been generated in the first learning process, evaluates each of the training data by applying each of the training data to the second model, excludes training data of a prescribed evaluation, and learns the first model.

In addition, a learning program according to the present invention is a learning program mounted on a computer including a training data storage means that stores training data used for generating a first model for determining a category to which given data belongs, the training data being associated with a predetermined correct answer category, and is characterized by causing the computer to execute a first learning process of learning the first model by machine learning using the training data, to execute a selecting process of determining a category to which the training data belongs by applying the training data to the first model, sorting training data based on a difference between a category that is a determination result and a correct answer category corresponding to the training data, selecting a predetermined number of pieces of higher training data as first training data, and selecting a predetermined number of pieces of lower training data as second training data, to execute a second learning process of learning a second model for evaluating training data by machine learning using the first training data and the second training data, to repeat the first learning process, the selecting process, and the second learning process until a prescribed condition is satisfied, and in a case where the second model has been generated in the first learning process, to evaluate each of the training data by applying each of the training data to the second model, to exclude training data of a prescribed evaluation, and to learn the first model.

### Advantageous Effects of Invention

According to the present invention, it is possible to accurately exclude training data inappropriate for learning a model from training data and to learn the model.

### BRIEF DESCRIPTION OF DRAWINGS

FIG. 1 It depicts a block diagram illustrating a configuration example of a learning device according to a first exemplary embodiment of the present invention.

FIG. 2 It depicts a schematic diagram illustrating selection of appropriate training data and inappropriate training data.

FIG. 3 It depicts a flowchart illustrating an example of process progress of a learning device of the present invention.

FIG. 4 It depicts a flowchart illustrating an example of process progress in step S101.

FIG. 5 It depicts a schematic diagram illustrating exclusion of training data.

FIG. 6 It depicts a flowchart illustrating an example of process progress in step S102.

FIG. 7 It depicts a block diagram illustrating an example of a learning device according to a second exemplary embodiment of the present invention.

FIG. 8 It depicts a block diagram illustrating an example of a learning device according to a third exemplary embodiment of the present invention.

FIG. 9 It depicts a schematic block diagram illustrating a configuration example of a computer according to each of exemplary embodiments of the present invention.

FIG. 10 It depicts a block diagram illustrating an outline of a learning device of the present invention.

### DESCRIPTION OF EMBODIMENTS

Exemplary embodiments of the present invention will be described below with reference to the drawings.

A learning device of the present invention learns a model for determining a category to which given data belongs by machine learning. Categories are various determination results of a determination process using a model. For example, in a case where a model for determining whether or not an object in an image corresponds to a prescribed object is learned, there are two types of categories, a category that “an object in an image corresponds to a prescribed object” and a category that “an object in an image does not correspond to a prescribed object”. However, the type of category is not limited to the two types. The type of category is determined depending on the type of training data to be used and the type of determination for which a model is learned. In addition, as described later, each of training data used for learning a model is associated with a correct answer category (a category representing a correct answer) predetermined for the training data. The correct answer category is predetermined, for example, by a user of the learning device according to the training data.

Note that in each of exemplary embodiments described below, a case where a model for determining a category to which given data belongs is learned by deep learning will be exemplified. In this case, each category obtained as a determination result by a determination process using the model is represented by a vector. Then, a correct answer category predetermined in association with each of training data is also represented by a vector.

### First Exemplary Embodiment

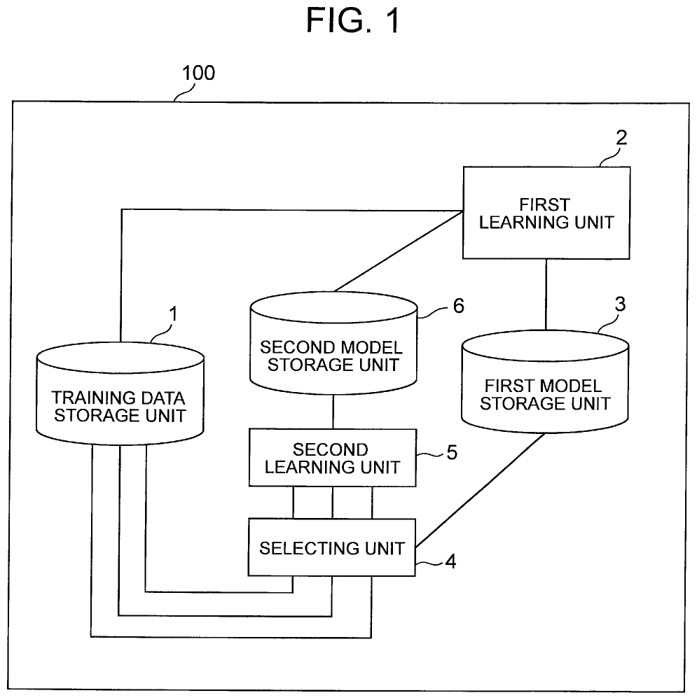

FIG. 1 is a block diagram illustrating a configuration example of a learning device according to a first exemplary embodiment of the present invention. A learning device 100 of the present invention includes a training data storage unit 1, a first learning unit 2, a first model storage unit 3, a selecting unit 4, a second learning unit 5, and a second model storage unit 6.

The learning device 100 not only learns a model for determining a category to which given data belongs by machine learning, but also learns a model for determining whether or not each of training data is appropriate as training data used for learning the model by machine learning. In order to distinguish the two models from each other, a model for determining a category to which given data belongs is referred to as a first model. In addition, a model for determining whether or not each of training data is appropriate as training data used for learning the first model is referred to as a second model.

The training data storage unit 1 is a storage device that stores a plurality of pieces of training data used for learning (generating) the first model. A predetermined correct answer category is associated with each of training data.

A case where a model for determining whether or not an object in an image corresponds to a prescribed object is learned as the first model will be exemplified. In this case, for example, a user of the learning device 100 (hereinafter, simply referred to as a user) collects a plurality of pieces of image data. Then, the user stores each piece of image data in the training data storage unit 1 in advance in association with a correct answer category. In a case where the user determines that an object in an image corresponds to a prescribed object, the user only needs to associate a correct answer category that “an object in an image corresponds to a prescribed object” with image data of the image. In addition, in a case where the user determines that an object in an image does not correspond to a prescribed object, the user only needs to associate a correct answer category that “an object in an image does not correspond to a prescribed object” with image data of the image.

Note that the training data is not limited to the above image data. The user only needs to store training data according to the type of determination for which a model is learned, as the first model, in the training data storage unit 1 in association with a correct answer category.

The first learning unit 2 learns the first model by machine learning using training data stored in the training data storage unit 1. In each of the exemplary embodiments, a case where the first learning unit 2 learns the first model by deep learning will be exemplified.

In addition, in a case where the second model (a model for determining whether or not each of training data is appropriate as training data used for learning the first model) has been generated, the first learning unit 2 determines whether each of training data is appropriate or inappropriate by applying each of the training data to the second model. Then, the first learning unit 2 learns the first model using training data remaining after excluding training data that has been determined to be inappropriate.

As described later, the learning device 100 repeats a process of the first learning unit 2, a process of the selecting unit 4, and a process of the second learning unit 5. In the first iteration, the second model has not been generated yet. In this case, the first learning unit 2 learns the first model using all pieces of training data stored in the training data storage unit 1. In addition, in the second or subsequent iteration, the second model has been generated. In this case, the first learning unit 2 determines whether each of training data is appropriate or inappropriate by applying each of the training data to the second model. Then, the first learning unit 2 learns the first model using training data remaining after excluding training data that has been determined to be inappropriate.

The first learning unit 2 stores the first model obtained by learning in the first model storage unit 3. The first model storage unit 3 is a storage device that stores the first model.

The selecting unit 4 reads each piece of training data from the training data storage unit 1. Then, for each correct answer category, the selecting unit 4 determines a category to which each of training data belongs by applying each of the training data to the first model. In each of the exemplary embodiments, the first learning unit 2 learns the first model by deep learning. In a case where a category to which data belongs is determined by a model obtained by deep learning, a determination result of a category is obtained as a vector. Therefore, a determination result of a category for each of training data is obtained as a vector. In addition, correct answer data associated with training data is also predetermined as a vector. For each correct answer category, regarding each of training data, the selecting unit 4 calculates a difference between a category determined for training data and correct answer data corresponding to the training data, and further sorts the training data based on the difference. Here, it is assumed that the selecting unit 4 sorts the training data in ascending order based on a value indicating the difference.

The selecting unit 4 performs the above process for each correct answer category associated with training data. Therefore, as a result of the above process, for example, each piece of training data associated with a correct answer category that “an object in an image corresponds to a prescribed object” is sorted, and each piece of training data associated with a correct answer category that “an object in an image does not correspond to a prescribed object” is sorted.

It can be said that training data having a small difference from correct answer data is appropriate as training data used for learning the first model. In addition, it can be said that training data having a large difference from correct answer data is inappropriate as training data used for learning the first model. Therefore, in the training data sorted in ascending order based on a value indicating the difference, higher training data can be said to be appropriate training data, and lower training data can be said to be inappropriate training data.

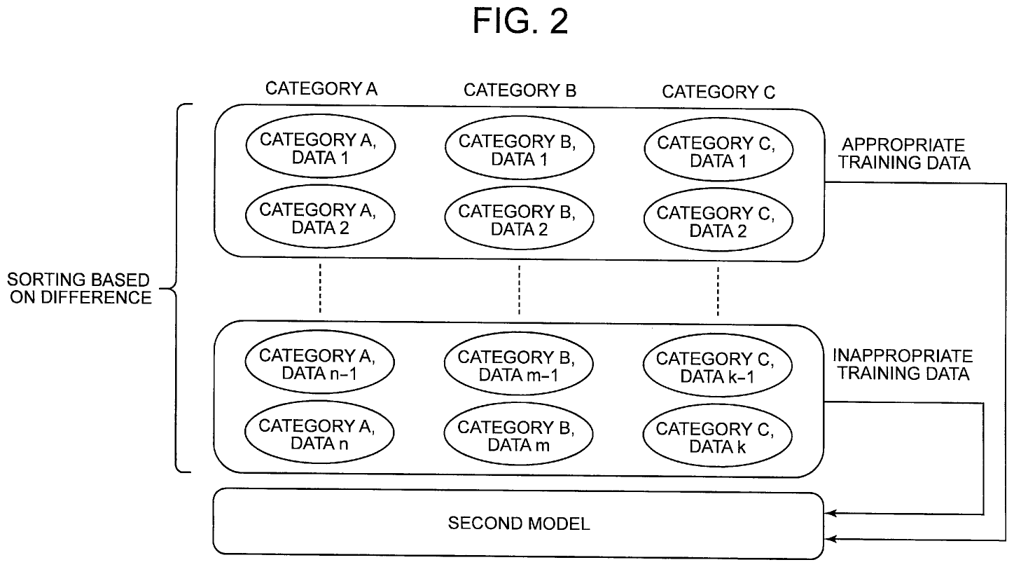

For each correct answer category, the selecting unit 4 selects a predetermined number of pieces of higher training data as appropriate training data and selects a predetermined number of pieces of lower training data as inappropriate training data from the training data sorted in ascending order. FIG. 2 is a schematic diagram illustrating selection of appropriate training data and inappropriate training data. FIG. 2 exemplifies a case where there are three types of correct answer categories, “category A”, “category B”, and “category C”. The selecting unit 4 sorts training data in which the correct answer category is “category A”, then selects a predetermined number of pieces of higher training data as appropriate training data, and selects a predetermined number of pieces of lower training data as inappropriate training data from the training data. The selecting unit 4 similarly performs a sorting process also regarding training data in which the correct answer category is “category B” and training data in which the correct answer category is “category C”, then selects a predetermined number of pieces of higher training data as appropriate training data, and selects a predetermined number of pieces of lower training data as inappropriate training data. The training data selected as appropriate training data and the training data selected as inappropriate training data serve as training data (teacher data) for learning the second model.

Note that by referring to the training data selected as appropriate training data as first training data and referring to the training data selected as inappropriate training data as second training data, the training data selected as appropriate training data and the training data selected as inappropriate training data may be distinguished from each other.

In addition, the selecting unit 4 may select appropriate training data and inappropriate training data regardless of a correct answer category. In this case, the selecting unit 4 only needs to sort each piece of training data regardless of a correct answer category based on a value indicating a difference between a category that has been determined for training data and correct answer data corresponding to the training data, to select a predetermined number of pieces of higher training data as appropriate training data, and to select a predetermined number of pieces of lower training data as inappropriate training data.

The second learning unit 5 learns the second model by machine learning using the training data selected as appropriate training data by the selecting unit 4 and the training data selected as inappropriate training data by the selecting unit 4 (in other words, using the training data as teacher data). The second learning unit 5 learns the second model regardless of a correct answer category collectively using the training data selected by the selecting unit 4. Therefore, the second learning unit 5 learns one second model even if there is a plurality of types of correct answer categories.

The second learning unit 5 stores the second model obtained by learning in the second model storage unit 6. The second model storage unit 6 is a storage device that stores the second model.

The learning device 100 repeats a process executed by the first learning unit 2 (which can be referred to as a first learning process), a process executed by the selecting unit 4 (which can be referred to as a selecting process), and a process executed by the second learning unit 5 (which can be referred to as a second learning process) until a prescribed condition is satisfied. An example of this prescribed condition is that the number of times of repetition has reached a predetermined number of times. Alternatively, another example of this prescribed condition is that in a case where training data selected as appropriate training data or inappropriate training data is applied to the second model, a difference between classification of the training data (“appropriate” or “inappropriate”) and a determination result obtained by applying the training data to the second model is equal to or less than a predetermined threshold value.

The first learning unit 2, the selecting unit 4, and the second learning unit 5 are implemented by, for example, a central processing unit (CPU) of a computer that operates according to a learning program. In this case, the CPU only needs to read a learning program from a program recording medium such as a program storage device of the computer, and to operate as the first learning unit 2, the selecting unit 4, and the second learning unit 5 according to the program.

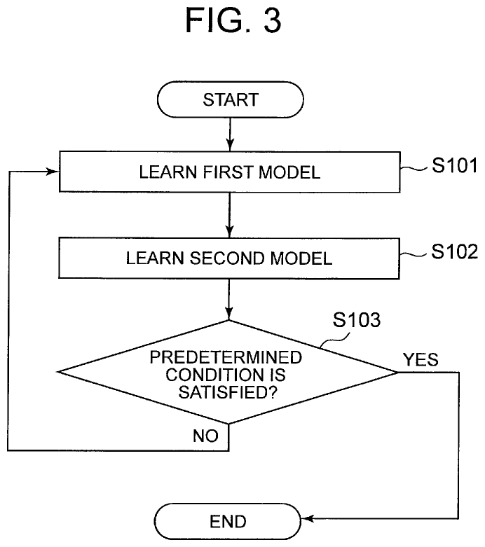

Next, process progress of the invention will be described. FIG. 3 is a flowchart illustrating an example of process progress of the learning device 100 of the present invention.

The first learning unit 2 learns the first model and stores the first model in the first model storage unit 3 (step S101). Specific process progress in step S101 will be described later.

Next, the learning device 100 learns the second model and stores the second model in the second model storage unit 6. (step S102). The process in step S102 includes a process in which the selecting unit 4 selects training data from training data stored in the training data storage unit 1 and a process in which the second learning unit 5 learns the second model using the selected training data. Specific process progress in step S102 will be described later.

After step S102, for example, the first learning unit 2 determines whether or not a prescribed condition is satisfied (step S103). If the prescribed condition is not satisfied (No in step S103), the learning device 100 repeats the processes in step S101 and subsequent step. If the prescribed condition is satisfied (Yes in step S103), the process ends.

As described above, an example of the prescribed condition is that the number of times of repetition has reached a predetermined number of times. For example, the first learning unit 2 only needs to determine whether or not the number of times of repetition has reached a predetermined number of times.

In addition, another example of the prescribed condition is that in a case where training data selected as appropriate training data or inappropriate training data is applied to the second model, a difference between classification of the training data (“appropriate” or “inappropriate”) and a determination result obtained by applying the training data to the second model is equal to or less than a predetermined threshold value. The process of determining whether or not training data is appropriate by applying the training data to the second model is performed by the first learning unit 2 in step S101. Therefore, the first learning unit 2 only needs to determine whether or not the above condition is satisfied.

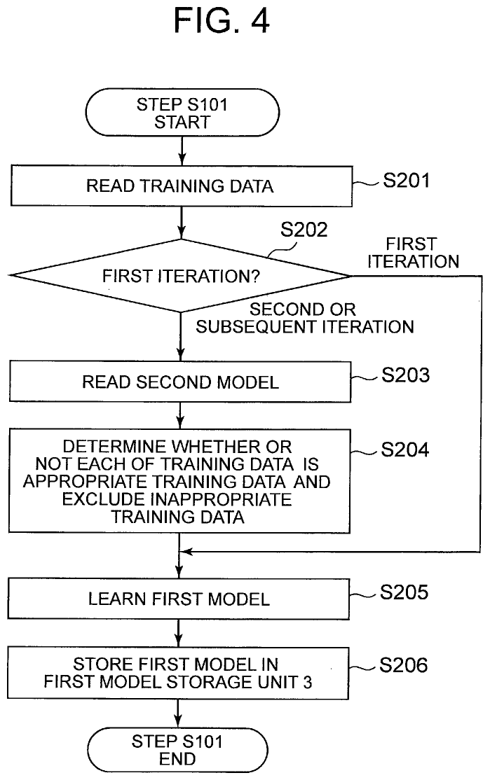

Next, the process in step S101 will be described more specifically. FIG. 4 is a flowchart illustrating an example of process progress in step S101.

In step S101, first, the first learning unit 2 reads each piece of training data from the training data storage unit 1 (step S201).

Next, the first learning unit 2 determines whether the current process is the first iteration of steps S101 to S103 (see FIG. 3) or the second or subsequent iteration of steps S101 to S103 (step S202).

In a case where the current process is the first iteration of steps S101 to S103, the second model has not been generated yet. Meanwhile, in a case where the current process is the second or subsequent iteration of steps S101 to S103, the second model has been generated and stored in the second model storage unit 6.

In a case where the current process is the first iteration, the process proceeds to step S205. In a case where the process proceeds from step S202 to step S205, in step S205, the first learning unit 2 learns the first model by machine learning using all the pieces of training data read from the training data storage unit 1.

In step S205, the first learning unit 2 learns the first model by machine learning performed by a method for repeatedly using training data. One example of the machine learning performed by the method for repeatedly using training data is deep learning. In each of the exemplary embodiments, a case where the first learning unit 2 learns the first model by deep learning using training data is exemplified. However, the first learning unit 2 does not execute learning all the necessary number of times as the number of times of repetition using training data, but ends learning when the number of times of repetition using training data has reached a certain number of times.

In addition, in a case where the current process is the second or subsequent iteration, the process proceeds to step S203. In step S203, the first learning unit 2 reads the second model from the second model storage unit 6.

After step S203, by applying each piece of each of training data read from the training data storage unit 1 in step S201 to the second model read in step S203, the first learning unit 2 determines whether or not each of the training data is appropriate as training data used for learning the first model. Then, the first learning unit 2 excludes training data that has been determined to be inappropriate from each piece of training data read from the training data storage unit 1 (step S204).

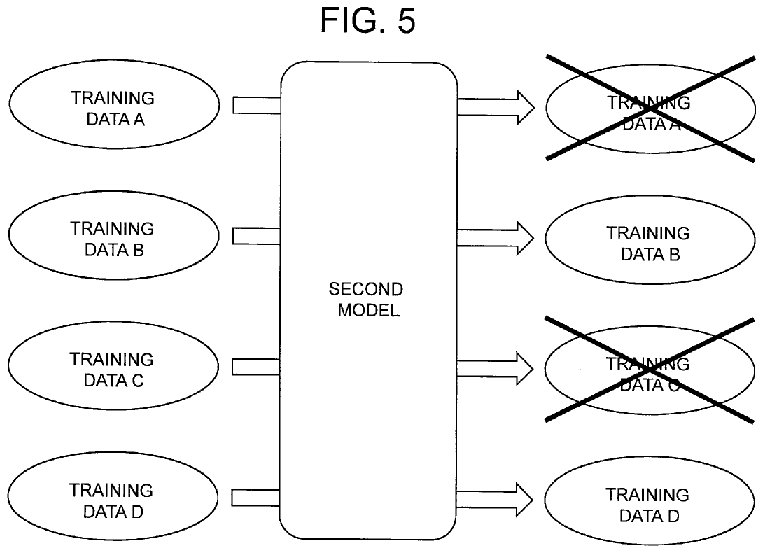

FIG. 5 is a schematic diagram illustrating exclusion of training data. The example illustrated in FIG. 5 indicates a case where the first learning unit 2 applies each of training data A, B, C, and D to the second model, and as a result, has determined that the training data A and C are inappropriate, and the training data B and D are appropriate. In a case where the process moves from step S204 to step S205, the first model is learned using training data remaining after excluding the training data A and C.

Since steps S101 to S103 (see FIG. 3) are repeatedly executed, the second model is updated every time steps S101 to S103 are repeated. Therefore, the second model is updated every time the process proceeds to step S204. Therefore, a determination result in step S204 for each of training data read from the training data storage unit 1 in step S201 can change. For example, even in a case where it is determined that certain training data is determined to be inappropriate in step S204, it can be determined that the training data is appropriate in step S204 in the next step S101.

In addition, in step S204, the first learning unit 2 may calculate a numerical value indicating a difference between classification of training data (“appropriate” or “inappropriate”) determined by the selecting unit 4 and a determination result obtained by applying the training data to the second model. Then, in step S103 (see FIG. 3), the first learning unit 2 may determine whether or not a prescribed condition is satisfied depending on whether or not the numerical value indicating the difference is equal to or less than a threshold value.

After step S204, the process proceeds to step S205. In a case where the process proceeds from step S204 to step S205, in step S205, the first learning unit 2 learns the first model by deep learning using training data remaining after excluding training data that has been determined to be inappropriate. As described above, the first learning unit 2 ends learning when the number of times of repetition using training data has reached a certain number of times.

After step S205, the first learning unit 2 stores the first model generated in step S205 in the first model storage unit 3 (step S206). In a case where the first model is stored in the first model storage unit 3, the first learning unit 2 updates the first model generated in the immediately preceding step S205 and stored in the first model storage unit 3.

In step S206, step S101 (see FIG. 3) ends.

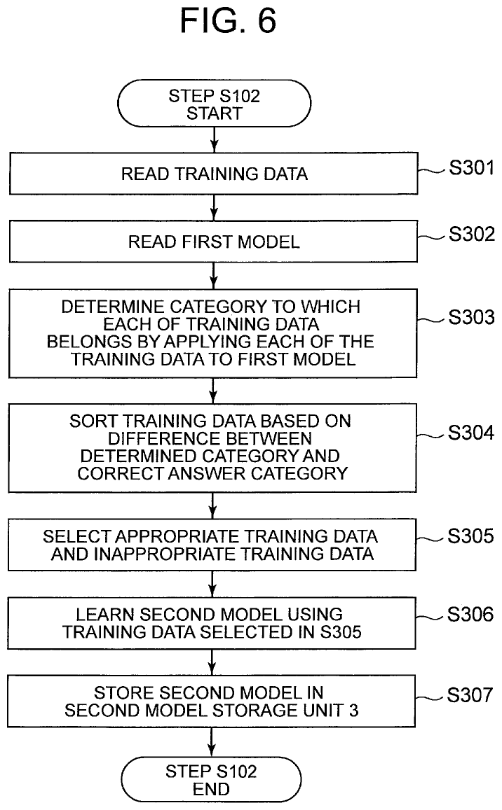

Next, the process of step S102 will be described more specifically. FIG. 6 is a flowchart illustrating an example of process progress in step S102.

In step S102, first, the selecting unit 4 reads each piece of training data from the training data storage unit 1 (step S301).

Next, the selecting unit 4 reads the first model from the first model storage unit 3 (step S302). This first model is a model learned in the immediately preceding step S205 (see FIG. 4).

Next, the selecting unit 4 determines a category to which each of training data belongs by applying each of the training data to the first model for each correct answer category (step S303). In step S303, when classifying the training data for each correct answer category, the selecting unit 4 refers to a correct answer category associated with each piece of training data. However, when determining a category to which each of training data belongs, the selecting unit 4 does not refer to a correct answer category.

In addition, the selecting unit 4 calculates a certainty factor for each category in a process of determining a category to which training data belongs by applying the training data to the first model. The certainty factor is a numerical value indicating ease with which training data belongs to a category of interest. The selecting unit 4 determines a category having the highest certainty factor as a category to which training data belongs.

Next to step S303, for each correct answer category, regarding each of training data, the selecting unit 4 calculates a difference between a category determined for training data in step S303 and correct answer data corresponding to the training data, and further sorts the training data based on the difference (step S304). Here, it is assumed that the selecting unit 4 sorts the training data in ascending order based on the difference.

An example of a method for calculating a value indicating a difference between a category determined in step S303 and a correct answer category will be described. As described above, in a case where a category to which data belongs is determined by a model obtained by deep learning, a determination result of a category is obtained as a vector. In addition, correct answer data is also predetermined as a vector.

For example, the selecting unit 4 may calculate a difference between a vector indicating the category determined in step S303 and a vector indicating the correct answer data, and may calculate an L1 norm of the difference as a value indicating the difference. Then, the selecting unit 4 may sort training data in ascending order for each correct answer category based on the L1 norm.

In addition, for example, the selecting unit 4 may calculate a difference between a vector indicating the category determined in step S303 and a vector indicating the correct answer data, and may calculate an L2 norm of the difference as a value indicating the difference. Then, the selecting unit 4 may sort training data in ascending order for each correct answer category based on the L2 norm.

In addition, the selecting unit 4 may sort training data based on the above-described certainty factor. Specifically, the selecting unit 4 may sort training data in ascending order for each correct answer category based on the certainty factor for a correct answer category corresponding to training data, the certainty factor being obtained in the process of determining a category of the training data.

After step S304, the selecting unit 4 selects appropriate training data and inappropriate training data as training data used for learning the first model (step S305).

For example, for each correct answer category, the selecting unit 4 selects a predetermined number of pieces of higher training data as appropriate training data and selects a predetermined number of pieces of lower training data as inappropriate training data from the training data sorted in ascending order.

Alternatively, the selecting unit 4 may sort each piece of training data regardless of a correct answer category, may select a predetermined number of pieces of higher training data as appropriate training data, and may select a predetermined number of pieces of lower training data as inappropriate training data.

Next to step S305, the second learning unit 5 learns the second model by machine learning collectively using all the pieces of training data selected as appropriate training data by the selecting unit 4 and all the pieces of training data selected as inappropriate training data by the selecting unit 4 (step S306).

After step S306, the second learning unit 5 stores the second model generated in step S306 in the second model storage unit 6 (step S307). In a case where the second model is stored in the second model storage unit 6, the second learning unit 5 updates the second model generated in the immediately preceding step S306 and stored in the second model storage unit 6.

In step S307, step S102 (see FIG. 3) ends.

After step S102, for example, the first learning unit 2 determines whether or not a prescribed condition is satisfied (step S103). If the prescribed condition is not satisfied (No in step S103), the processes in step S101 and subsequent step are repeated. If the prescribed condition is satisfied (Yes in step S103), the process ends.

According to the first exemplary embodiment, the selecting unit 4 selects appropriate training data as training data used for learning the first model and inappropriate training data. Then, the second learning unit 5 learns the second model by machine learning collectively using all the pieces of training data selected by the selecting unit 4. Then, the first learning unit 2 determines whether each of training data stored in the training data storage unit 1 is appropriate or inappropriate by applying each of the training data to the second model. Then, the first learning unit 2 learns the first model using training data remaining after excluding training data that has been determined to be inappropriate. Therefore, it is possible to exclude training data inappropriate for learning the first model from each of training data and to learn the first model.

In addition, the second model for determining whether or not each of training data is appropriate as training data used for learning the first model is learned, each piece of each of the training data is applied to the second model, and it is thereby determined whether each of the training data is appropriate or inappropriate. Therefore, it is possible to accurately determine and exclude inappropriate training data.

In addition, inappropriate training data is accurately excluded, and the first model is learned. Therefore, a category of given data can be accurately determined by applying the data to the first model.

### Second Exemplary Embodiment

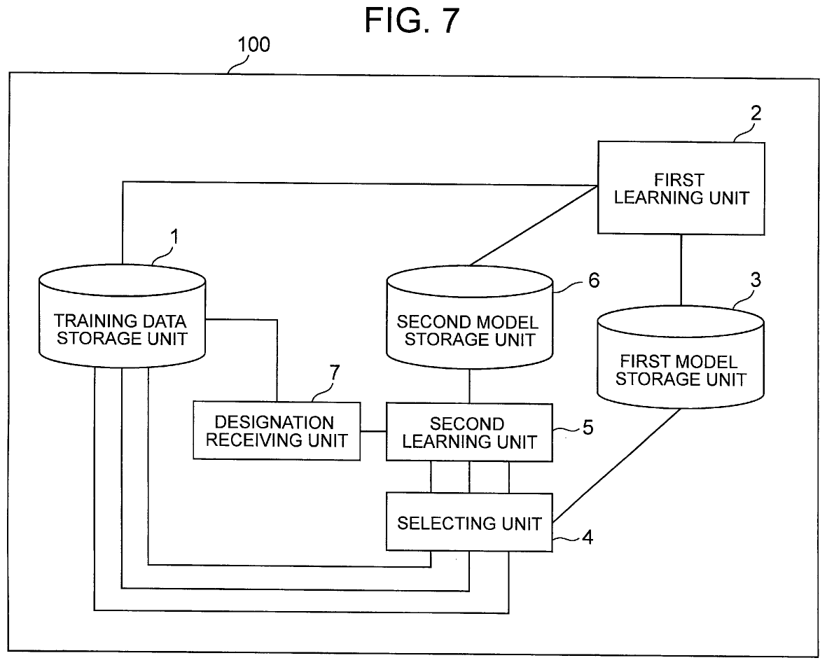

A learning device according to a second exemplary embodiment of the present invention receives designation of whether or not training data is appropriate. FIG. 7 is a block diagram illustrating an example of the learning device according to the second exemplary embodiment of the present invention. Similar elements to those illustrated in FIG. 1 are denoted by the same reference numerals as those in FIG. 1, and description thereof is omitted. A learning device 100 according to the second exemplary embodiment of the present invention further includes a designation receiving unit 7 in addition to the elements included in the learning device 100 according to the first exemplary embodiment (see FIG. 1).

The designation receiving unit 7 receives designation of whether or not each of training data stored in a training data storage unit 1 is appropriate from a user. For example, after step S305 (see FIG. 6), the designation receiving unit 7 reads each piece of training data from the training data storage unit 1 and displays each of training data on a display device (not illustrated in FIG. 7) included in the learning device 100. Then, the designation receiving unit 7 only needs to receive designation of whether or not each of the training data is appropriate as training data used for learning a first model via a graphic user interface (GUI) displayed on the display.

After the above operation of the designation receiving unit 7, the process proceeds to step S306. In step S306, a second learning unit 5 learns a second model using training data selected as appropriate training data by a selecting unit 4, training data selected as inappropriate training data by the selecting unit 4, training data designated as appropriate training data by a user, and training data designated as inappropriate training data by the user.

At this time, in a case where the training data selected as appropriate training data by the selecting unit 4 is designated as inappropriate data by the user, the second learning unit 5 gives priority to the designation by the user, and learns the second model by assuming that the training data is inappropriate training data.

Similarly, in a case where the training data selected as inappropriate training data by the selecting unit 4 is designated as appropriate data by the user, the second learning unit 5 gives priority to the designation by the user, and learns the second model by assuming that the training data is appropriate training data.

The designation receiving unit 7 is implemented by, for example, a CPU of a computer that operates according to a learning program. In this case, the CPU only needs to read a learning program from a program recording medium such as a program storage device of the computer, and to operate as a first learning unit 2, the selecting unit 4, the second learning unit 5, and the designation receiving unit 7 according to the program.

According to the second exemplary embodiment, it is possible to incorporate a user's determination as to whether or not training data is appropriate.

### Third Exemplary Embodiment

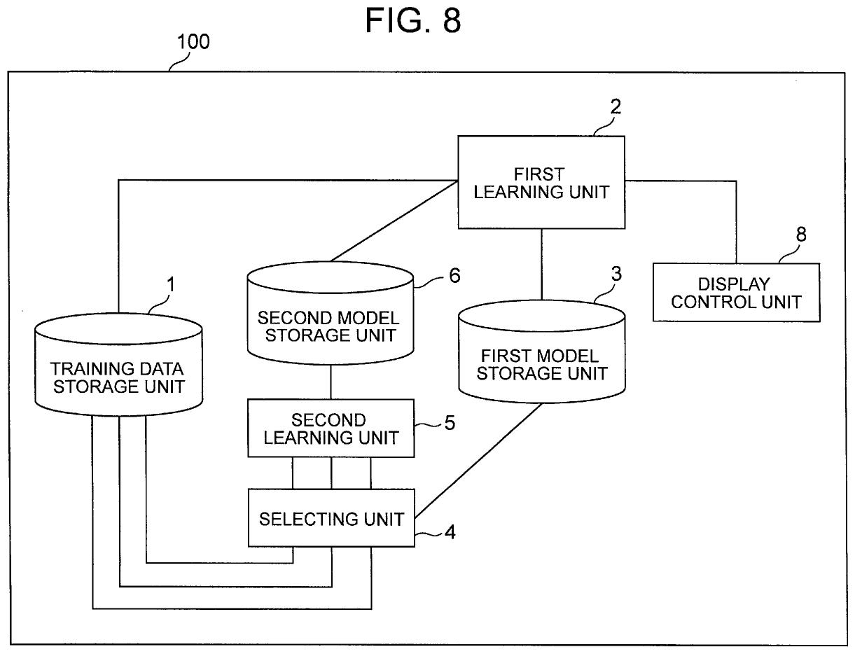

FIG. 8 is a block diagram illustrating an example of a learning device according to a third exemplary embodiment of the present invention. Similar elements to those illustrated in FIG. 1 are denoted by the same reference numerals as those in FIG. 1, and description thereof is omitted. A learning device 100 according to the third exemplary embodiment of the present invention further includes a display control unit 8 in addition to the elements included in the learning device 100 according to the first exemplary embodiment (see FIG. 1).

The display control unit 8 displays each piece of training data that has been determined to be inappropriate by a first learning unit 2 in step S204 on a display device (not illustrated in FIG. 8) included in the learning device 100.

The display control unit 8 is implemented by, for example, a CPU of a computer that operates according to a learning program. In this case, the CPU only needs to read a learning program from a program recording medium such as a program storage device of the computer, and to operate as the first learning unit 2, a selecting unit 4, a second learning unit 5, and the display control unit 8 according to the program.

According to the present exemplary embodiment, the display control unit 8 displays training data determined to be inappropriate as training data used for learning a first model on the display device. Therefore, the training data determined to be inappropriate can be presented to a user. In the third exemplary embodiment, it can be said that inappropriate training data is detected and presented to a user.

In addition, the third exemplary embodiment may be applied to the second exemplary embodiment.

In the above description, as the first model, a model for determining whether or not an object in an image corresponds to a prescribed object has been exemplified. The first model is not limited to such a model. For example, the first model may be a model for classifying a small product whose posture is difficult to fix (for example, a screw) in an image in a case where image data of the image including the small product is given.

In addition, for example, the first model may be a model for classifying a natural object (stone, tree, or the like) in an image in a case where image data of the image including the natural object is given.

In addition, for example, the first model may be a model for classifying an object in an image imaged in an environment affected by disturbance (outdoors or the like) in a case where image data of the image is given.

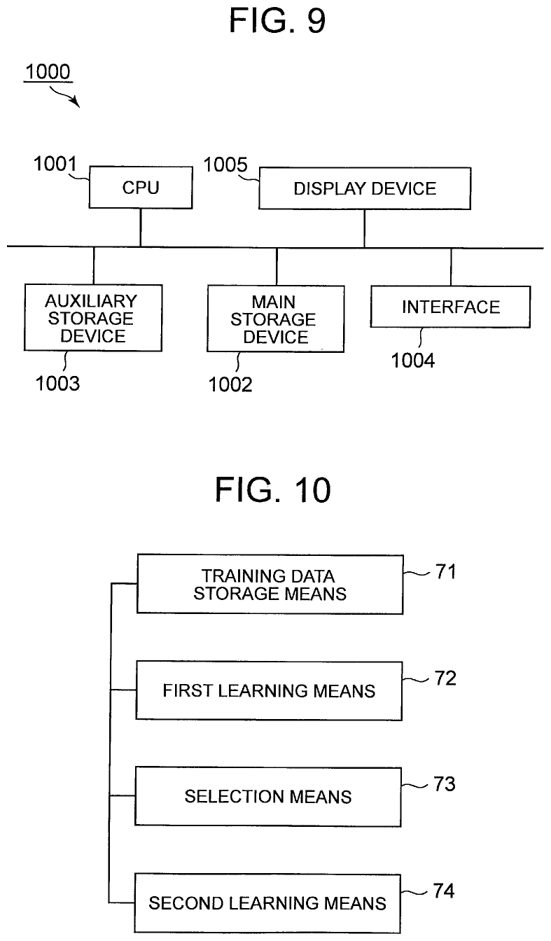

FIG. 9 is a schematic block diagram illustrating a configuration example of a computer according to each of the exemplary embodiments of the present invention. A computer 1000 includes a CPU 1001, a main storage device 1002, an auxiliary storage device 1003, an interface 1004, and a display device 1005.

The learning device 100 according to each of the exemplary embodiments of the present invention is mounted on the computer 1000. Operation of the learning device 100 is stored in the auxiliary storage device 1003 in a form of a learning program. The CPU 1001 reads out the learning program from the auxiliary storage device 1003, expands the learning program in the main storage device 1002, and executes the processes described in each of the above exemplary embodiments according to the learning program.

The auxiliary storage device 1003 is an example of a non-transitory tangible medium. Other examples of the non-transitory tangible medium include a magnetic disk connected through the interface 1004, a magneto-optical disk, a compact disk read only memory (CD-ROM), a digital versatile disk read only memory (DVD-ROM), and a semiconductor memory. In addition, in a case where a program is distributed to the computer 1000 via a communication line, the computer 1000 that has received the distribution may expand the program in the main storage device 1002 and may execute the above processes.

Next, the outline of the present invention will be described. FIG. 10 is a block diagram illustrating an outline of a learning device of the present invention. The learning device of the present invention includes a training data storage means 71, a first learning means 72, a selecting means 73, and a second learning means 74.

The training data storage means 71 (for example, the training data storage unit 1) stores training data used for generating the first model for determining a category to which given data belongs, the training data being associated with a predetermined correct answer category.

The first learning means 72 (for example, the first learning unit 2) executes the first learning process of learning the first model by machine learning using training data.

The selecting means 73 (for example, the selecting unit 4) executes a selecting process of determining a category to which training data belongs by applying the training data to the first model, sorting training data based on a difference between a category that is a determination result and a correct answer category corresponding to the training data, selecting a predetermined number of pieces of higher training data as first training data, and selecting a predetermined number of pieces of lower training data as second training data.

The second learning means 74 (for example, the second learning unit 5) executes a second learning process of learning the second model for evaluating training data by machine learning using the first training data and the second training data.

Then, execution of the first learning process by the first learning means 72, execution of the selecting process by the selecting means 73, and execution of the second learning process by the second learning means 74 are repeated until a prescribed condition is satisfied.

In addition, in a case where the second model has been generated in the first learning process, the first learning means 72 evaluates each of the training data by applying each of the training data to the second model, excludes training data of a prescribed evaluation, and learns the first model.

With such a configuration, it is possible to accurately exclude training data inappropriate for learning the first model from training data and to learn the first model.

In addition, a configuration may be adopted in which the second learning means 74 learns, as a second model, a model for determining whether training data is appropriate or inappropriate as training data used for learning the first model in the second learning process, and in a case where the second model has been generated in the first learning process, the first learning means 72 determines whether each of the training data is appropriate or inappropriate by applying each of the training data to the second model, excludes training data that has been determined to be inappropriate, and learns the first model.

In addition, a configuration may be adopted in which in the selecting process, the selecting means 73 determines a category to which training data belongs by applying the training data to the first model for each correct answer category, and sorts training data based on a difference between a category that is a determination result and a correct answer category corresponding to the training data.

In addition, a configuration may be adopted in which in the selecting process, the selecting means 73 sorts training data in ascending order based on a difference between a category that is a determination result and a correct answer category.

In addition, a configuration may be adopted in which a designation receiving means (for example, the designation receiving unit 7) that receives designation of whether or not training data is appropriate from a user is included, and the second learning means 74 learns the second model using training data selected as the first training data by the selecting means 73, training data selected as the second training data by the selecting means 73, training data designated as appropriate training data by the user, and training data designated as inappropriate training data by the user.

In addition, a configuration may be adopted in which a display control means (for example, the display control unit 8) that displays training data of a prescribed evaluation to be excluded (for example, training data that has been determined to be inappropriate by the first learning unit 2 in the first learning process) is included.

In addition, a configuration may be adopted in which in the selecting process, the selecting means 73 sorts training data based on a norm of a difference between a category determination result represented by a vector and correct answer data represented by a vector.

Hereinabove, the present invention has been described with reference to the exemplary embodiments, but the invention of the present application is not limited to the above exemplary embodiments. Various modifications that can be understood by those skilled in the art can be made to the configuration and details of the invention of the present application within the scope of the invention of the present application.

This application claims priority based on Japanese Patent Application 2018-063833 filed on Mar. 29, 2018, and the entire disclosure thereof is incorporated herein.

### INDUSTRIAL APPLICABILITY

The present invention is suitably applied to a learning device that learns a model for determining a category to which data belongs by machine learning.

### REFERENCE SIGNS LIST

1 Training data storage unit
2 First learning unit
3 First model storage unit
4 Selecting unit
5 Second learning unit
6 Second model storage unit
7 Designation receiving unit
8 Display control unit
100 Learning device

What is claimed is:

1. A learning device comprising:
a training data storage unit that stores training data used for generating a first model for determining a category to which given data belongs, the training data being associated with a correct answer category;
a first learning unit that executes a first learning process of learning the first model by machine learning using the training data;
a selecting unit that executes a selecting process of determining a category to which the training data belongs by applying the training data to the first model, sorting the training data based on a difference between the category that is a determination result and a correct answer category corresponding to the training data, selecting a predetermined number of pieces of higher training data as first training data, and selecting a predetermined number of pieces of lower training data as second training data; and
a second learning unit that executes a second learning process of learning a second model for evaluating training data by machine learning using the first training data and the second training data, wherein
the first learning unit, the selecting unit and the second learning unit repeat execution of the first learning process, the selecting process, and the second learning process respectively until a prescribed condition is satisfied, and wherein
the first learning unit evaluates, in a case where the second model has been generated, each of the training data by applying each of the training data to the second model, excludes the training data with a prescribed evaluation result, and learns the first model.

2. The learning device according to claim 1, wherein
the second learning unit learns, as a second model, a model for determining whether training data is appropriate or inappropriate as training data used for learning the first model in the second learning process, and
the first learning unit determines, in a case where the second model has been generated in the first learning process, whether each of the training data is appropriate or inappropriate by applying the each of the training data to the second model, excludes training data that has been determined to be inappropriate, and learns the first model.

3. The learning device according to claim 1, wherein
in the selecting process, the selecting unit determines a category to which training data belongs by applying the training data to the first model for each correct answer category, and sorts training data based on a difference between a category that is a determination result and a correct answer category corresponding to the training data for each correct answer category.

4. The learning device according to claim 1, wherein
in the selecting process, the selecting unit sorts training data in ascending order based on a difference between a category that is a determination result and a correct answer category.

5. The learning device according to claim 1, comprising
a designation receiving unit that receives designation of whether or not training data is appropriate from a user, wherein
the second learning unit learns the second model using training data selected as the first training data by the selecting unit, training data selected as the second training data by the selecting unit, training data designated as appropriate training data by the user, and training data designated as inappropriate training data by the user.

6. The learning device according to claim 1, comprising
a display control unit that displays training data of a prescribed evaluation to be excluded.

7. The learning device according to claim 1, wherein
in the selecting process, the selecting unit sorts training data based on a norm of a difference between a category determination result represented by a vector and correct answer data represented by a vector.

8. A learning method applied to a computer including a training data storage unit that stores training data used for generating a first model for determining a category to which given data belongs, the training data being associated with a correct answer category, the learning method comprising:
executing a first learning process of learning the first model by machine learning using the training data,
executing a selecting process of determining a category to which the training data belongs by applying the training data to the first model, sorting the training data based on a difference between the category that is a determination result and a correct answer category corresponding to the training data, selecting a predetermined number of pieces of higher training data as first training data, and selecting a predetermined number of pieces of lower training data as second training data,
executing a second learning process of learning a second model for evaluating training data by machine learning using the first training data and the second training data,
repeating the first learning process, the selecting process, and the second learning process until a prescribed condition is satisfied, and
evaluating, in a case where the second model has been generated, each of the training data by applying each of the training data to the second model, to exclude the training data with a prescribed evaluation result, and to learn the first model.

9. The learning method according to claim 8, wherein the learning method further comprises:
learning, as a second model, a model for determining whether training data is appropriate or inappropriate as training data used for learning the first model in the second learning process, and
determining, in a case where the second model has been generated in the first learning process, whether each of the training data is appropriate or inappropriate by applying each of the training data to the second model, excludes training data that has been determined to be inappropriate, and learns the first model.

10. A non-transitory computer-readable recording medium recording a learning program, the learning program mounted on a computer including a training data storage unit that stores training data used for generating a first model for determining a category to which given data belongs, the training data being associated with a correct answer category, the learning program causing the computer to perform
executing a first learning process of learning the first model by machine learning using the training data,
executing a selecting process of determining a category to which the training data belongs by applying the training data to the first model, sorting the training data based on a difference between the category that is a determination result and a correct answer category corresponding to the training data, selecting a predetermined number of pieces of higher training data as first training data, and selecting a predetermined number of pieces of lower training data as second training data,
executing a second learning process of learning a second model for evaluating training data by machine learning using the first training data and the second training data,
repeating the first learning process, the selecting process, and the second learning process until a prescribed condition is satisfied, and
evaluating, in a case where the second model has been generated, each of the training data by applying the each of the training data to the second model, to exclude the training data with a prescribed evaluation result, and to learn the first model.
